(19) United States
(12) Patent Application Publication
(10) Pub. No.: US 2018/0291674 A1
(43) Pub. Date: Oct. 11, 2018

(54) SEALING DEVICE

(71) Applicant: PLANET GDZ AG, Tagelswangen (CH)

(72) Inventor: Andreas DINTHEER, Illnau (CH)

(21) Appl. No.: 15/522,508

(22) PCT Filed: Oct. 26, 2015
(86) PCT No.: PCT/EP2015/074727

§ 371 Date: Apr. 27, 2017

(30) Foreign Application Priority Data
Oct. 27, 2014 (EP) 14190499.5
Oct. 27, 2014 (EP) 14190501.8

(51) Int. Cl. E06B 7/215; E06B 7/23

(52) U.S. Cl. CPC E06B 7/215; E06B 7/2316

(57) ABSTRACT

A sealing device for a door or window leaf comprises a housing rail (1), an actuating mechanism and a sealing strip that is retained in the housing rail (1) and can be moved relative to the housing rail (1) by the actuating mechanism. In the actuated state of the sealing device, the sealing strip seals at the end faces in both directions of a longitudinal axis (L) of the sealing device. Said S seal can be used as resistance to the penetration of heavy rain and floodwater.

### TECHNICAL FIELD

The present invention relates to a seal device, in particular to a drop-down seal.

### PRIOR ART

Door seals are usually employed in areas where light ingress is intended to be prevented and/or sound insulation is intended to be ensured. Lowerable door seals usually consist of a housing in the form of a downwardly open, U-shaped profile rail, of a sealing strip, having a sealing element, that is held in said housing and is displaceable relative to the latter, and of a lowering mechanism for lowering and raising the sealing strip. The sealing strip usually drops automatically when the door is closed in that a force in the longitudinal direction acts on an actuating rod and sets the mechanical lowering mechanism into operation counter to a spring force. Such door seals are known for example from EP 0 338 974, DE 195 16 530, EP 0 509 961 and EP 2 085 559.

Other types of lowering mechanisms are known for example from AU 2007/237192 and AU 2012/00490. In AU 2012/12100488, the entire seal is closed off at the end side by means of a cover plate, wherein only the actuating button protrudes.

Furthermore, drop-down seals are being increasingly employed also for doors and windows which separate an interior space from an outer side of a building. The requirements placed on these seals are more stringent since they have to provide protection in particular also from moisture. Driving rain, i.e. rain which is taken out of its vertical dropping direction by the wind, and accumulated water, i.e. water which lies on the ground in front of the window or door and presses against the seal, represent a particular challenge.

### SUMMARY OF THE INVENTION

Therefore, it is an object of the invention to create an improved seal device which can be formed in particular as a drop-down seal.

The seal device according to the invention for a door leaf or window casement has a housing rail, an actuating mechanism and a sealing strip which is held in the housing rail and is movable relative to the housing rail by means of the actuating mechanism, with the result that the sealing strip is in particular raisable and lowerable. In the actuated state of the seal device, the sealing strip provides end-side sealing in both directions of a longitudinal axis of the seal device.

This seal device can interact with a seal element, for example a sealing cushion, arranged in the ground beneath the door leaf or window casement, in order to ensure ground-side sealing. However, the seal device itself preferably has a sealing element which provides sealing with respect to the ground. By virtue of the lateral seal, the sealing action is increased.

If the seal device is used together with ground-side sealing, it can be used as protection against driving rain and floodwater.

If the basis is a drop-down seal which is supplemented by the lateral seal, optimal results are obtained, wherein the seal can be formed in a small and slender manner such that it scarcely limits the design variety of the door or window.

In a simple embodiment, the seal device is manually actuable. However, it is preferably automatically actuable. Preferably, it is automatically actuable by means of a mechanically triggerable mechanism, in particular displaceable outward and lowerable at the same time.

In a preferred embodiment, at least a part of the sealing strip is movable outward in both directions of the longitudinal axis in order to provide end-side sealing. This part can be a support rail which holds a sealing profile. However, this part can also be a pressure plate which presses against a seal profile.

If the end-side sealing and the ground-side sealing are effected with the same seal profile, the number of parts and the production costs are minimized.

In a preferred embodiment, the sealing strip has a one-piece or multipiece support rail or a support unit.

Preferably, the support rail is movable outward in the direction of the longitudinal axis of the seal device in order for the sealing strip to provide end-side sealing.

Preferably, the support rail is provided with an adjustable pressure plate on at least one of its end sides, preferably on both end sides.

Preferably, in the outwardly moved and lowered state of the sealing strip, the support rail protrudes beyond the housing rail on both end sides, wherein it does not protrude beyond the end sides in the raised state of the housing rail. As a result, when it is not in use, i.e. when the door leaf is open, it is not disruptive. Preferably, it is displaced outward during the closing of the door leaf and/or during lowering.

In another embodiment, the support rail can be moved outward in both directions, without a lateral seal being present or the lateral seal being increased thereby. This is a separate invention, for which protection is hereby likewise requested. The movement of the support rail can take place while or before the seal is lowered. It can be a seal that is not automatically lowerable, for example a brush seal. Depending on the embodiment, the support rail can protrude in the outwardly moved state of the housing rail or can have such short dimensions that it does not protrude even then. The latter can be necessary for example for design reasons.

The outward movement of the support rail preferably takes place by means of a reversing movement, i.e. a force applied to a triggering rod in one direction is converted into a movement of the support rail in the opposite direction. In this case, the force transmission preferably takes place exclusively by the use of slides, or force transmission rods or plates, that are displaceable in the longitudinal direction of the seal. If one-sided triggering is provided, a force transmission in the opposite direction can preferably be coupled with a force transmission in the same direction in that a reversal element, for example a pivoting element, is used.

Preferably, the support rail has at least a first and a second support-rail part which are arranged one behind the other in a spaced-apart manner along the longitudinal axis and the spacing of which from one another is variable.

In a preferred embodiment, the actuating mechanism has a force transmission rod that is displaceable in the longitudinal direction, a pivoting element and a displacement element. The force transmission rod is displaceable parallel to the longitudinal axis and brings about a movement of the sealing strip. The pivoting element is pivotable about a pivot axis perpendicular to the longitudinal axis during longitudinal displacement of the force transmission rod. The displacement element is displaceable parallel to the longitudinal axis and in the opposite direction to the displacement of the force transmission rod by the pivoting element pivoting. The first support-rail part is connected to the displacement element and the second support-rail part is connected to the force transmission rod such that the displacement element displaces the first support-rail part outward and such that the force transmission rod displaces the second support-rail part outward in the opposite direction to the first support-rail part. This is thus one-sided activation of the actuating mechanism.

Known means are suitable as the pivoting element. A lever or a gearwheel is preferred.

The pivoting element is a lever, wherein the force transmission rod and the displacement element each have a guide cam, said guide cams being engaged with the lever and moving the lever upon movement of the force transmission rod or the displacement element, respectively.

In another embodiment, the pivoting element is a gearwheel, wherein the force transmission rod and the displacement element each have a rack, said racks being engaged with the gearwheel and moving the gearwheel upon movement of the force transmission rod or the displacement element, respectively.

In another embodiment, two-sided activation is provided. In this embodiment, the actuating mechanism has a first force transmission rod that is displaceable in the longitudinal direction and a second force transmission rod that is displaceable counter to the longitudinal direction, wherein the two force transmission rods are displaceable parallel to the longitudinal axis and bring about a movement of the sealing strip. The first support-rail part is connected to the second force transmission rod and the second support-rail part is connected to the first force transmission rod such that the second force transmission rod displaces the first support-rail part outward in a direction parallel to its own displacement direction and such that the first force transmission rod displaces the second support-rail part outward in the opposite direction to the first support-rail part in a direction parallel to its own displacement direction. In this case, a reversal element, or pivoting element, is not necessary.

In a further embodiment, two-sided activation is likewise provided. However, the displacement direction of the support-rail parts is in the opposite direction to the displacement direction of the respective force transmission rods. The force transmission thus takes place in a crosswise manner, with reversal elements being used for this purpose. In this embodiment, the first support-rail part is connected to the first force transmission rod and the second support-rail part is connected to the second force transmission rod via respective reversal elements, preferably pivoting elements. The first force transmission rod displaces the first support-rail part and the second force transmission rod displaces the second support-rail part.

In all three of the above-described variants of the actuating mechanism, the drive which brings about the horizontal or lateral displacement of the sealing strip can be coupled to a lowering mechanism, wherein the coupling is effected with very simple means. This is space-saving, robust and cost-effective.

In order that the two support-rail parts are displaceable as far as possible in a horizontal direction, i.e. along the longitudinal axis, in a preferred embodiment, the at least first and second support-rail parts each have a guide element at their mutually adjacent end sides, said guide elements being connected together and allowing a relative movement of adjacent support-rail parts exclusively parallel to the longitudinal axis.

In preferred embodiments, the seal device is a drop-down seal. For this purpose, the sealing strip is lowerable and raisable transversely to the longitudinal axis of the seal device. The sealing strip has the support rail for fastening the sealing strip to the housing rail and a seal profile held on the support rail, in order to seal a gap between the door leaf or window casement and the ground in the lowered state of the sealing strip.

Preferably, the seal device is an automatically lowerable and raisable seal. Preferably, it is mechanically triggered.

Preferably, the seal profile simultaneously provides sealing downwardly and on both end sides in the lowered state. This minimizes the number of parts of the seal device and thus also the production costs.

The seal profile is preferably manufactured from an elastomeric or rubber-elastic material, for example silicone or rubber.

Preferably, the sealing strip is lowerable and raisable by means of the actuating mechanism; i.e. the actuating mechanism is the lowering mechanism of the drop-down seal. As a result, the number of elements of the seal is in turn minimized and the seal can be configured in a relatively narrow manner.

In a preferred embodiment, each support-rail part has its own, separate seal-profile part. However, the seal profile is preferably formed in one piece lengthwise and is held jointly by the at least two support-rail parts. In this way, the seal is optimized because the sealing line between the two support-rail parts is not interrupted.

Preferably, the seal profile is formed in a manner closed in a watertight manner at least on one end side, preferably on both end sides, and at least over half of its height, preferably over approximately its entire height. As a result, no water can penetrate into and remain in the seal profile. Moisture damage can thus be avoided.

Alternatively, the seal profile can also be provided with outlet openings, such that water that has penetrated into the seal profile can flow out again.

Preferably, the seal profile is formed in one piece lengthwise and is held jointly by the at least two support-rail parts.

Preferably, the displacement element or the second force transmission rod lowers the first support-rail part and displaces it outward, and the force transmission rod or the first force transmission rod lowers the second support-rail part and displaces it outward in the opposite direction to the first support-rail part.

In a preferred embodiment, a triggering element is provided which actuates the actuating mechanism, and an additional module is provided which is arranged outside the housing rail and which is actuable by means of the triggering element. The additional module has a sealing body which is movable in the direction of the sealing strip when the additional module is actuated, with the result that, in the actuated state of the seal device, the sealing body contacts the sealing strip on an end side of the sealing strip and, together with the latter, seals the door leaf or window casement with respect to a door casing or a wall.

The additional module preferably has a spring-loaded lever mechanism for displacing the sealing body.

Preferably, the sealing body is formed in an elastic and watertight manner.

This additional module can be combined with the seal device already described above. However, it can also be combined with lowering mechanisms as are known from the prior art and which displace the sealing strip in a sealing manner against the door casing or the wall on only one end side. The additional module likewise ensures sealing abutment on the opposite side and thus ensures that the door is sealed off with respect to water toward the ground and toward the two end sides of the door leaf.

In preferred embodiments, the seal can be optimized or adjusted on site so as to match the spacing between the door leaf and frame and/or between the bottom end side of the door leaf and the ground. To this end, preferably adjustable pressure plates are provided. These pressure plates are preferably provided on at least one of the end sides thereof, preferably on both end sides.

Preferably, the lowering mechanism is based on the proven mechanism with one-sided triggering, as is used in the seals according to EP 0 338 974, DE 195 16 530, EP 0 509 961 and EP 2 085 559. Preferably, for this purpose, the force transmission rod and the displacement element are held in a groove in the housing rail so as to be displaceable parallel to the longitudinal axis. In these preferred embodiments, the lowering mechanism comprises at least one leaf spring per support-profile rail part, wherein a first leaf spring of the first support-profile rail part is connected at a first end to the housing rail, at a second end to the displacement element and in a central region to the first support-profile rail part, and wherein a second leaf spring of the second support-profile rail part is connected at a first end to the force transmission rod, at a second end to the housing rail and in a central region to the second support-profile rail part.

Preferably, the seal profile is formed in one piece in cross section. Preferably, it has a lower arc which rests in a sealing manner on the ground in the lowered state, and two legs that laterally adjoin said arc, project upward along side walls of the support rail and bear against the inner walls of the housing rail in a sliding and sealing manner. Other forms, in particular two-piece and multipiece cross sections of the seal profile can also be used, however.

Preferably, the seal profile is held so as to be displaceable in the longitudinal direction relative to the support rail, at least in a central region with respect to the longitudinal axis, preferably along its entire length. As a result, the seal profile is not overextended during the lateral displacement of the support rail, in particular when the two support-rail parts move apart from one another.

In a preferred embodiment, the seal profile has at least one fastening bead on each side, preferably on the inner side, said fastening bead extending in the longitudinal direction and being held in a corresponding recess in the support rail. Preferably, the fastening bead of the seal profile has a size, at least in the central region of its length, preferably along its entire length, that ensures sufficient clearance in the recess in the support rail. The seal profile can also be fastened to the support rail by other means. The seal profile can furthermore be fastened at only one point for example on both sides. Preferably, it is fastened to the support rail two, three or several times on both sides. The at least one fastening is preferably configured so as to be nondestructively releasable.

In a further preferred embodiment, in order to seal a gap between a door leaf or window casement and the ground, the seal device has a housing rail and a sealing strip, held therein, having a support rail and a seal profile, wherein the support rail is held in the housing rail and the seal profile is held on the support rail. The support rail has a substantially U-shaped cross section with a lower connecting web and two side walls. Furthermore, at least two further spaced-apart connecting webs are provided, wherein each of the connecting webs connects the two side walls together.

Thus, the support rail substantially has a box profile. Its height is preferably 31 to 100 mm, more preferably 60 to 80 mm.

Preferably, the abovementioned robust support rail results in a sealing strip having a lateral seal height of 20 to 80 mm, more preferably 20 to 60 mm.

This support rail is formed in a robust manner and withstands even a relatively high water pressure from the outside. In addition, it can be configured in a higher manner than the known support rails such that it allows effective sealing even in the event of a relatively high level of accumulated water. It is possible, but not necessary, for this seal device not to exhibit a lateral seal by means of the sealing strip.

Preferably, the seal profile of this embodiment extends over approximately the entire height of the side walls of the support rail, wherein it is fastened at at least two, preferably at least three points over this height of the side walls. This prevents the seal profile from being forced off the support rail by driving rain or accumulated water. The seal remains intact even under extreme conditions.

Preferably, the seal profile has fastening beads which extend in the longitudinal direction, are arranged in a spaced-apart manner one above another and are held in recesses in the support rail. The fastening beads preferably have a firtree-shaped cross section.

In preferred embodiments, the seal profile is formed in one piece for this robust support rail. Preferably, the seal profile has an arc which extends beneath the lower connecting web and rests on the ground in a sealing manner in the lowered state of the seal. Preferably, on both sides of the support profile, the seal profile additionally or alternatively has upwardly extending legs which bear in a sliding and sealing manner against an inner side of the housing rail.

This seal device having the robust support rail can be configured as a brush seal. Preferably, it has a lowering mechanism, however, wherein the sealing strip is lowerable and raisable relative to the housing rail and transversely to a longitudinal axis of the seal device. Preferably, the movement takes place automatically, wherein the activation preferably takes place mechanically.

In order that this seal is effective even at a high level of accumulated water or in the event of heavy driving rain, an actuating button that protrudes from the end side of the housing rail is located above the uppermost end of the seal profile. This actuating button activates the lowering of the sealing strip. As a result of its arrangement, it does not interrupt the lateral sealing line.

In preferred embodiments, the seal is triggered on one side. In other preferred embodiments, it is configured to be a seal that is able to be triggered or is triggered on both sides.

Preferably, the seal profile is formed in a manner closed at the end sides in the embodiments without lateral displacement, too, such that no water can penetrate into the seal. This is a separate invention which is likewise claimed here.

Preferably, the seal profile is configured in a trough-like manner with end sides that are closed in a watertight manner. This makes production easier and reduces the number of connecting points, i.e. of possible weak points, in the seal profile.

The seal profile preferably consists of a main body and the end walls that are fastened thereto. The end walls are preferably adhesively bonded or welded to the main body. The main body is formed in one piece in preferred embodiments. However, it can also be configured in a two-piece or multipiece manner, wherein the individual pieces are preferably connected together in a watertight manner. Preferably, they are welded or adhesively bonded together.

A seal profile according to the invention, which can preferably be used in one of the above embodiments, is configured in a trough-like manner with end sides that are closed in a watertight manner. This seal profile can also be used in other seal devices, however, for example in brush seals. Furthermore, it can also be configured in a closed manner on only one end side, wherein the opposite end side remains open. This one-sided arrangement is advantageous for example when two or more seals are arranged one after the other. This is also a separate invention which is likewise claimed here.

Further embodiments are specified in the dependent claims. Embodiments and principles of the invention which are described in this text and/or illustrated in the drawings but are not yet explicitly claimed in the claims are nevertheless claimed as inventions and will, if necessary, be formulated subsequently in independent or dependent claims.

### BRIEF DESCRIPTION OF THE DRAWINGS

Preferred embodiments of the invention are described in the following text with reference to the drawings, which serve merely for illustration and should not be interpreted as being limiting. In the drawings:

FIG. 1a shows a longitudinal section through a seal device according to the invention in the raised state, according to a first embodiment;

FIG. 1b shows a cross section through the seal device according to FIG. 1a;

FIG. 2a shows a longitudinal section through the seal device according to FIG. 1a in the lowered state;

FIG. 2b shows a cross section through the seal device according to FIG. 2a;

FIG. 3a shows a longitudinal section through the central plane axis of the seal device in the raised state according to FIG. 1a;

FIG. 3b shows a cross section through the seal device according to FIG. 3a;

FIG. 4a shows a longitudinal section through the central plane axis of the seal device according to FIG. 3a in the lowered state;

FIG. 4b shows a cross section through the seal device according to FIG. 4a;

FIG. 5 shows an enlarged cross section of FIG. 3b;

FIG. 6 shows an exploded illustration of a lowering mechanism of the seal device according to FIG. 3a;

FIG. 7 shows a view of the seal device according to FIG. 4b, wherein the individual planes in FIG. 6 are specified;

FIG. 8 shows a view from above of a displacement mechanism of the seal device according to FIG. 3a;

FIG. 9 shows a view from above of a second embodiment of a displacement mechanism;

FIG. 10 shows an enlarged longitudinal section of a central region of the seal device according to FIG. 3a in the raised state of the seal;

FIG. 11 shows an enlarged longitudinal section of a central region of the seal device according to FIG. 4a in the lowered state of the seal;

FIG. 12 shows a perspective illustration of a seal profile according to the invention in a first embodiment;

FIG. 13 shows an exploded illustration of the seal profile according to FIG. 12;

FIG. 14a shows a perspective illustration of a seal profile according to the invention in a second embodiment;

FIG. 14b shows an exploded illustration of the seal profile according to FIG. 14a;

FIG. 15a shows a perspective illustration of a part of a seal profile according to the invention according to a third embodiment;

FIG. 15b shows a longitudinal section through the seal profile according to FIG. 15a;

FIG. 15c shows a perspective illustration of a part of a seal profile according to the invention according to a fourth embodiment;

FIG. 15d shows a longitudinal section through the seal profile according to FIG. 15c;

FIG. 16 shows a longitudinal section through an end region of the seal device according to FIG. 3a;

FIG. 17a shows a longitudinal section through a seal device according to the invention in the raised state, according to a second embodiment;

FIG. 17b shows a cross section through the seal device according to FIG. 17a;

FIG. 18a shows a longitudinal section through the seal device according to FIG. 17a in the lowered state;

FIG. 18b shows a cross section through the seal device according to FIG. 18a;

FIG. 19 shows an exploded illustration of a lowering mechanism of the seal device according to FIG. 17a;

FIG. 20 shows a perspective illustration of a door leaf having a seal system according to the invention in a third embodiment;

FIG. 21 shows a cross section through the door leaf according to FIG. 20;

FIG. 22 shows a schematic illustration of the seal system according to FIG. 20;

FIG. 23 shows a further schematic illustration of the seal system according to FIG. 20;

FIG. 24 shows a perspective illustration of a seal according to the invention in a fourth embodiment;

FIG. 25a shows a side view of the seal according to FIG. 24;

FIG. 25b shows a view of the seal according to FIG. 24 from the front;

FIG. 26 shows a perspective illustration of the seal profile of the seal according to FIG. 24;

FIG. 27a shows a longitudinal section through the seal according to FIG. 25a;

FIG. 27b shows a cross section through the seal according to FIG. 25a;

FIG. 27c shows a longitudinal section through a seal according to a further embodiment;

FIG. 28a shows a perspective illustration of a part of a support rail in a further embodiment;

FIG. 28b shows a longitudinal section through a part of the drop-down seal with the support rail according to FIG. 28a;

FIG. 29 shows a schematic illustration of a drop-down seal with an additional module for end-side sealing according to a further embodiment;

FIG. 30a shows a perspective, schematic illustration of the additional module according to FIG. 29, embedded in a door casing and in a non-triggered position;

FIG. 30b shows the additional module in the door casing according to FIG. 30a in the triggered position, and

FIG. 30c shows the additional module in the door casing according to FIG. 30b with a schematically illustrated drop-down seal.

Identical parts are provided with the same reference signs.

### DESCRIPTION OF PREFERRED EMBODIMENTS

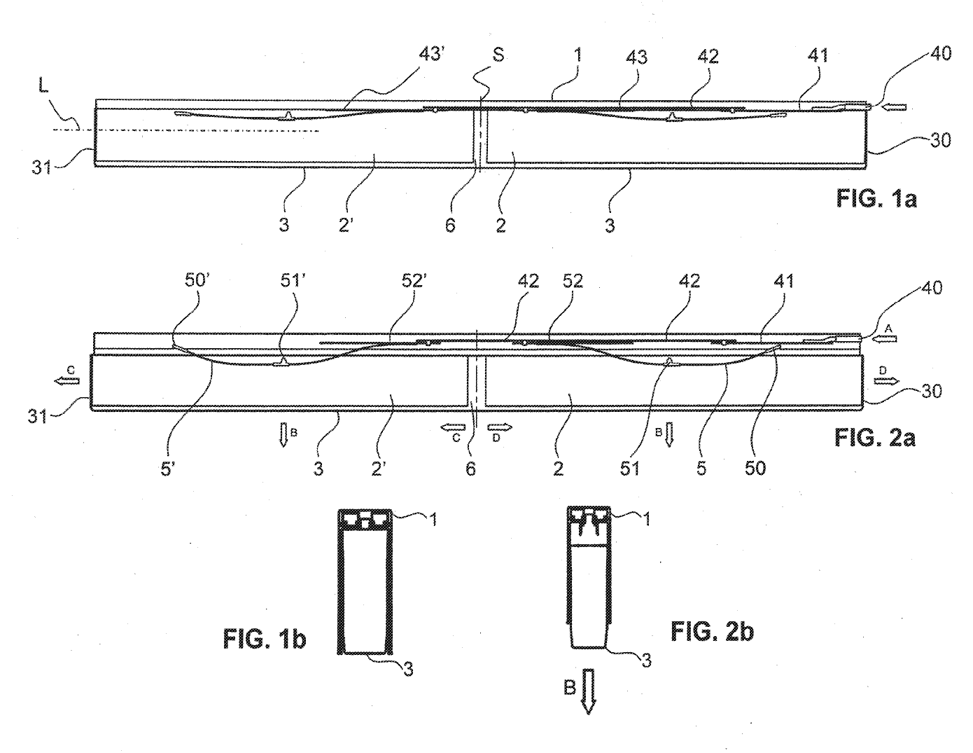

A first embodiment of the drop-down seal according to the invention is disclosed in FIGS. 1 to 7. Said drop-down seal has, like the known seals, a housing rail 1 in which a sealing strip is held in a lowerable and raisable manner. The sealing strip comprises a support rail 2, 2′ and an elastomeric or rubber-elastic seal profile 3 which is fastened to the sealing strip 2, 2′. The support rail consists of at least two, preferably exactly two support-profile parts 2, 2′ which are arranged one behind the other along a longitudinal axis L of the seal. The support-profile rail 2, 2′ and the seal profile 3 are preferably configured in an identical or similar manner, as disclosed in EP 0 338 974.

In FIGS. 1a and b, the sealing strip is illustrated in the raised state, and in FIGS. 2a and b, it is illustrated in the lowered state.

The drop-down seal has a spring-loaded lowering mechanism 4 which is able to be activated by means of an actuating button 40. The lowering mechanism 4 has a first slide 41 which is connected at one end to the actuating button 40 and at the other end to a force transmission rod 42. The force transmission rod 42 acts on a second slide 43. In addition, it is connected at its second end to a third slide 43′. These elements all extend parallel to a longitudinal axis L of the seal and are held so as to be guided in an upper groove 10 or in a lower groove 17, respectively, of the housing rail 1.

The lowering mechanism 4 furthermore comprises leaf springs 5, 5′. A first leaf spring 5 is fastened to the housing rail 1 in a pivotable manner by a first end. This forms the first fastening point 50. In a central region, it is fastened to the first support-rail part 2. This forms the second fastening point 50. At a second end, it is fastened to the second slide 43. This forms the third fastening point 52. The second leaf spring 5′ is fastened to the housing rail 1 in a pivotable manner by a first end at a first fastening point 50′, to the second support-profile part 2′ in a central region at a second fastening point 51′, and to the third slide 43′ by a second end at a third fastening point 52′. The two first fastening points 50, 50′ are located in the region of the end-side ends of the seal, and the two third fastening points 52, 52′ are adjacent to one another.

The actuating button 40 protrudes from the housing rail 1 at one end side. It is depressed by the door frame when the door leaf is closed and thus displaces the first slide 41 and the force transmission rod 42 in a longitudinal direction of the drop-down seal. As a result, the leaf springs 5, 5′ are compressed and the support rail 2, 2′ is lowered together with the seal profile 3. The force in the longitudinal direction is indicated by the arrow A in FIG. 2a, and the lowering movement is indicated by the arrow B. When the door leaf is opened, the force is no longer applied to the actuating button 40, the leaf springs 5, 5′ relax, the sealing strip is raised again and the actuating button 40 is pushed back out of the end side of the housing rail 1.

However, according to the invention, the sealing strip not only provides sealing with respect to the floor in the lowered state, but also on the end sides in both directions of the longitudinal axis L. This is achieved in the examples described here in that the sealing strip is moved outward in both longitudinal directions. When the sealing strip is lowered, the two support-rail parts 2, 2′ are moved away from one another by virtue of the second and third slides 43, 43′ and the connection or coupling thereof to the force transmission rod 42, such that their spacing 6 apart increases and they each protrude from one end side of the housing rail 1. This is illustrated by the arrows C and D in FIG. 2a. A pivot axis of the lowering mechanism is denoted S.

When the door leaf is opened or when the sealing strip is lowered, the longitudinal displacement of the support-profile parts 2, 2′ is reversed by virtue of the leaf springs 5, 5′ acting as restoring springs, and the spacing 6 between the support-profile parts 2, 2′ decreases again.

The drop-down seal according to the invention thus couples the lowering or raising of the sealing strip with a longitudinal displacement of the sealing strip in both longitudinal directions, wherein the movements preferably take place at the same time. In addition, the same mechanism is used for these movements.

The seal profile 3 is formed in one piece and fastened to the two support-profile parts 2, 2′. The seal profile 3 is pushed outward on both sides during the lateral displacement of the support-profile parts 2, 2′, and preferably extended. It has end-side portions which at least partially, preferably entirely, cover the outer end sides of the support-profile parts 2, 2′. These portions form a hinge-side termination 30 and a lock-side termination 31, which accordingly provide sealing with respect to the hinge-side frame and the lock-side frame of the door casing.

The seal profile 3 is preferably formed elastically enough for it to be able to be stretched or extended when the support-profile parts 2, 2′ are displaced, without tearing and without impeding the displacement.

The seal can be extensible along the entire length or have zones, in particular central zones in the longitudinal direction, which have increased extensibility. The extensibility is in this case increased at least in the longitudinal direction.

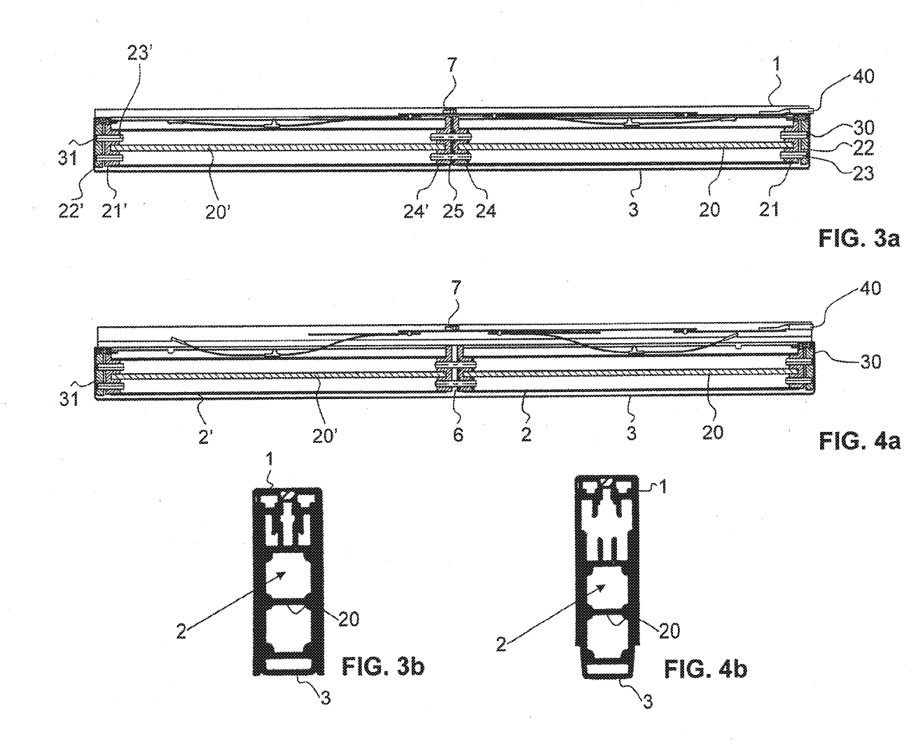

The longitudinal displacement of the support-profile parts 2, 2′ preferably takes place in a guided manner, as is discernible from FIGS. 3 to 16. In the following text, examples for the coupling between the force transmission rod 42 and second slide 43 are given.

FIGS. 3a and b again show the seal according to the invention in the raised state, and FIGS. 4a and b show the same seal in the lowered state.

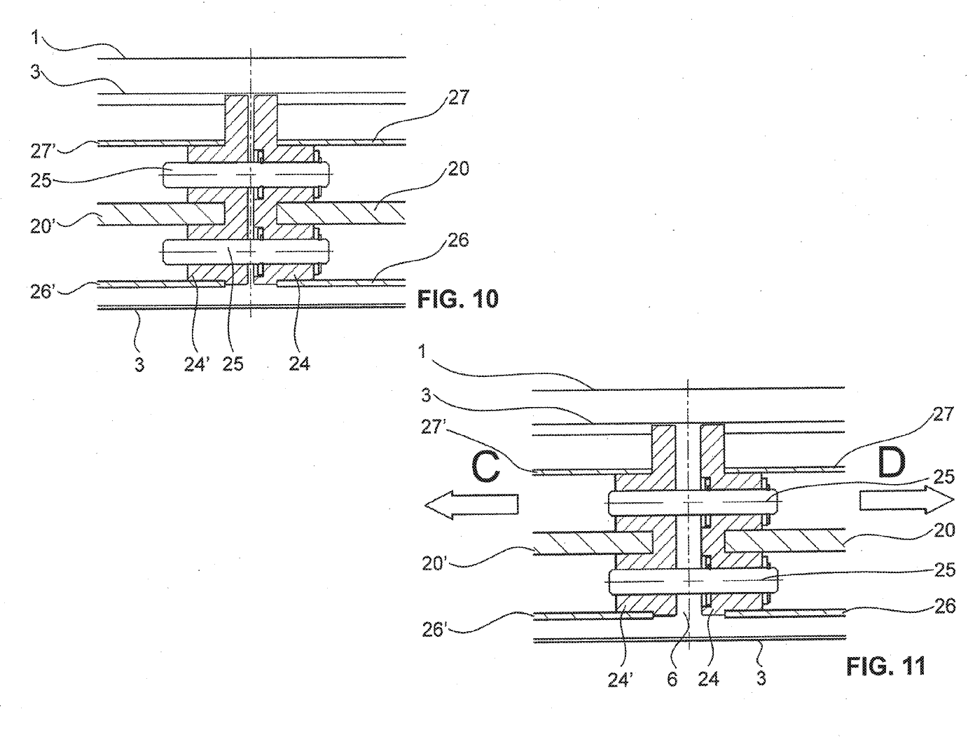

The adjacent ends of the support-rail parts 2, 2′ are each provided with a guide plate 24, 24′. The latter are connected together by one or more guide pins 25 that extend in the longitudinal direction, wherein at least one of the plates 24, 24′ is held so as to be displaceable along the guide pins 25. Preferably, as is discernible in FIG. 10, a first guide plate 24 is firmly connected to the guide pins 25 and a second guide plate 24′ is held so as to be displaceable with respect to the guide pins. FIG. 10 shows the arrangement with the sealing strip raised, and FIG. 11 with the sealing strip lowered.

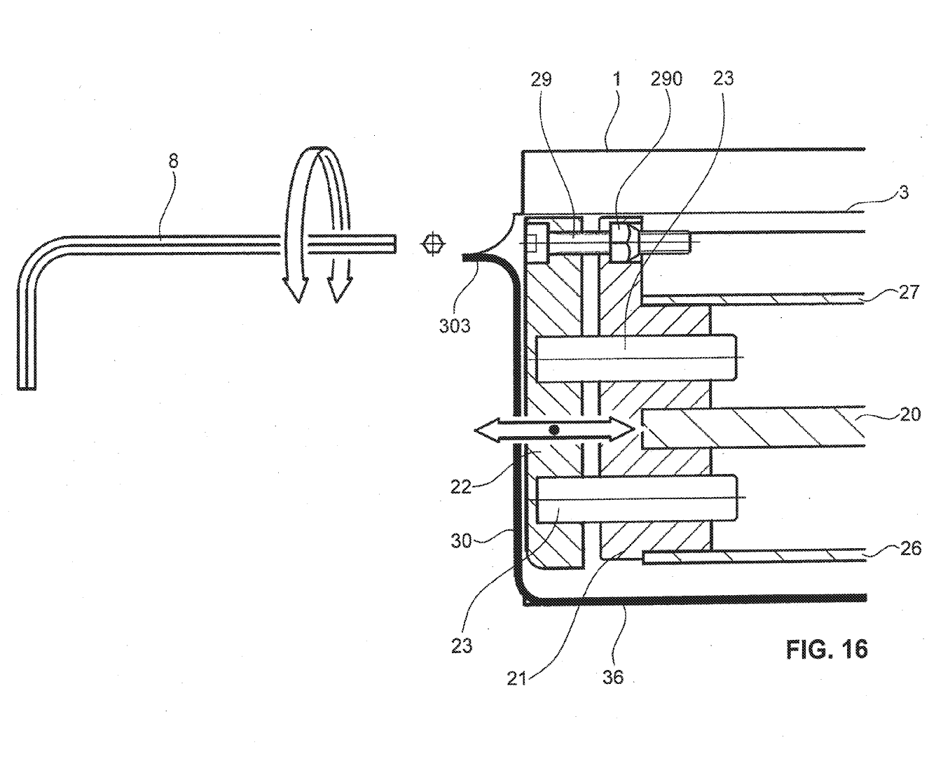

As is discernible in FIGS. 3a and 4a, the outer ends of the support-rail parts 2, 2′ are provided with stop plates 21, 21′. As counterparts, pressure plates 22, 22′ are connected to the stop plates 21, 21′ by guide pins 23, 23′. The spacing between each pressure plate 22, 22′ and associated stop plate 21, 21′ is settable and fixable by means of a setting screw 29 and corresponding locknut 290. This is readily discernible in FIG. 16. As a result, it is possible to set how far the sealing strip projects from the housing rail 1 on both sides in the lowered state. Thus, the contact pressure of the seal profile 3 against the frame of the door casing can be set. It is advantageous for the setting to take place individually on each side and to be independent of the opposite side.

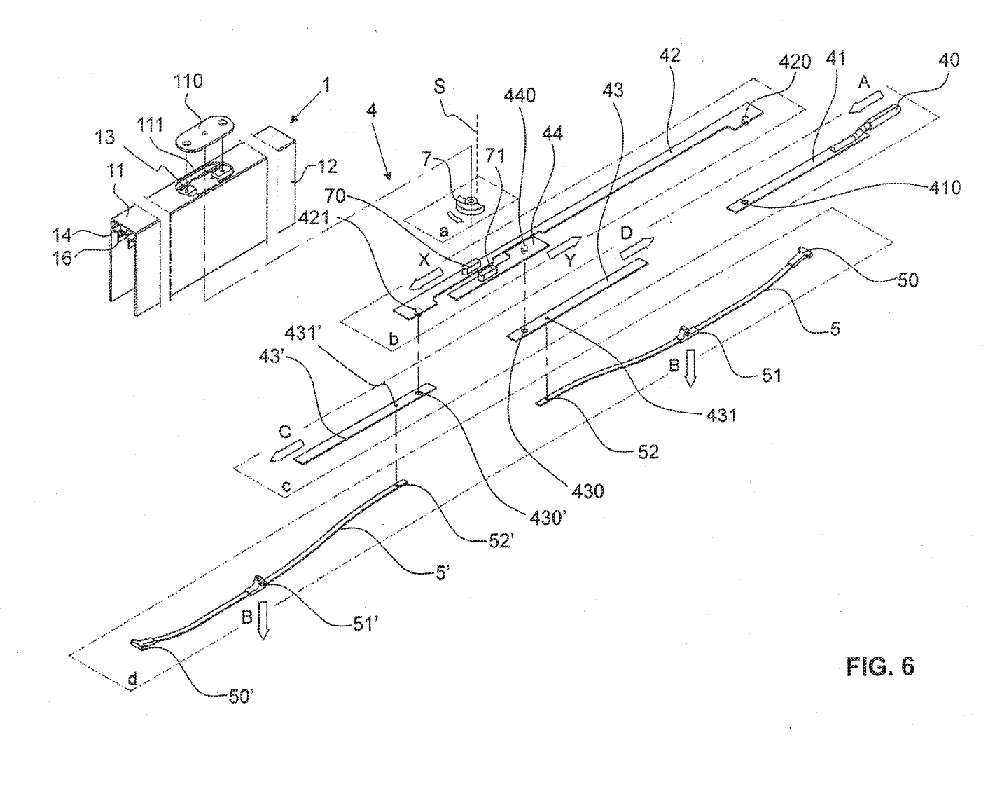

The drive mechanism is illustrated in detail in FIGS. 6, 8 and 9. The individual parts have already been described above and will not be repeated again. FIG. 6 shows that the slides 41, 43, 43′ and the force transmission rod 42 are preferably flat rods which have been welded, screwed, riveted or connected together in some other way, for example via a plug connection. The corresponding fastening bolts or fastening points of the connections illustrated here bear the reference numerals 420, 421, 431 and 431′, and the associated recesses or fastening points bear the reference numerals 410, 410′, 430, 430′, 52 and 52′.

A type of coupling between the force transmission rod 42 and second slide 43 is now also illustrated in FIG. 6. A displacement plate 44 is provided which is preferably arranged at the same height as the force transmission rod 42. The force transmission rod 42 preferably has an L-shaped recess, wherein the displacement plate 44 forms an L-shaped counterpart thereto. This configuration allows the central connection, in the transverse direction of the housing rail 1, to the slides 41, 43, 43′ and the likewise central arrangement of the force transmission element between the force transmission rod 42 and displacement plate 44. The second slide 43 is fixed to one end of the displacement plate 44 by its end. The fastening bolt is designated by the reference numeral 440. The associated recess is designated 430.

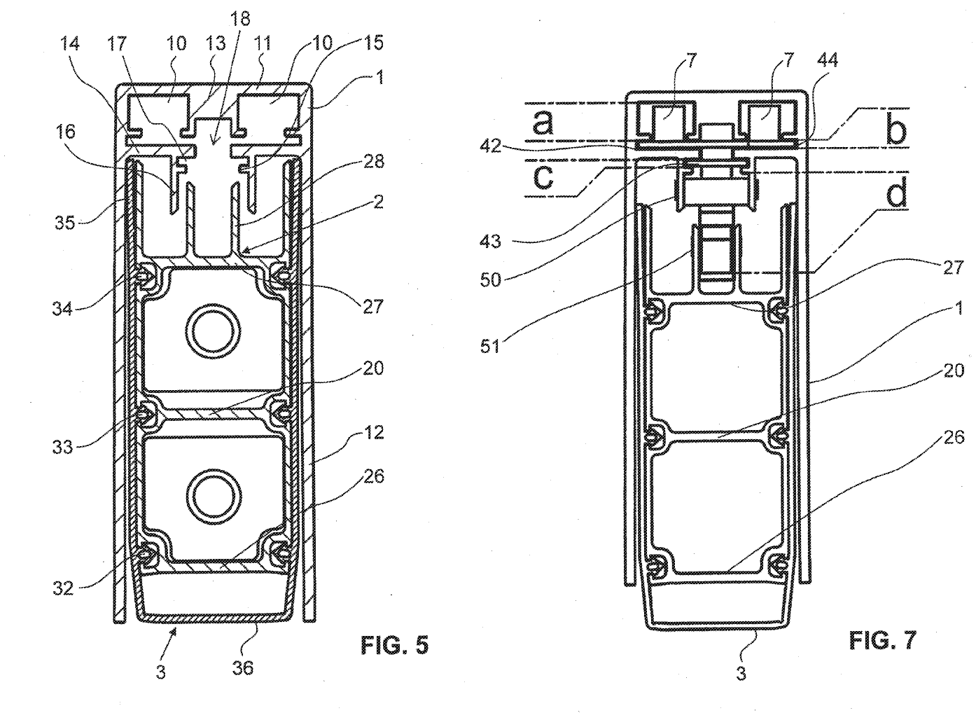

The other end region of the displacement plate 44 is operatively connected to the force transmission rod 42 via the force transmission element, in this case a lever connection. A lever 7 is fastened to a plate 110 so as to be pivotable about the pivot axis S. This plate is illustrated in FIG. 6. It is a cover plate 110 which closes an access opening 111 in the upper web 11 of the housing rail 1. It can be fastened, preferably screwed, to a central partition 13 (see FIG. 5). This configuration allows easy mounting of the lever 7 from above with inserted slides.

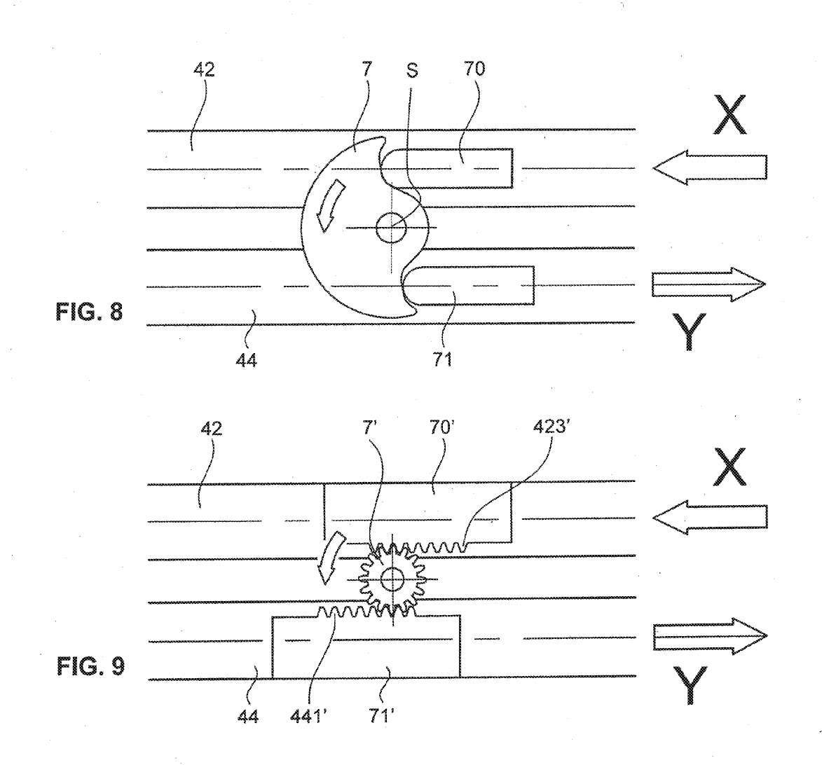

A first guide cam 70 is arranged on the force transmission rod 42, and a second guide cam 71, extending parallel thereto, is arranged on the displacement plate 44. Both guide cams 70, 71 are engaged with the semicircular, curved lever 7. This is readily discernible in FIG. 8. If the force transmission rod 42 is now pushed in the direction “X” while the door is being closed, the lever 7 rotates, as illustrated by the arrow in FIG. 8, and pushes the displacement plate 44 in the opposite direction “Y”. As a result, the displacement plate 44 pushes the second slide 43 in the same direction, wherein this movement is denoted “D” in FIG. 6. It thus moves in the opposite direction to the external force application. Since the first leaf spring 5 is fastened to this second slide 43, to the first support-rail part 2 (FIG. 2A) and to the housing rail 1, it is pushed in the direction “D” and bent. It thus both lowers the first support-rail part 2 in the direction “B” and pushes it outward in the direction “D” on the hinge side. The third slide 43′ is displaced in the direction “C” in the direction of the external force application by means of the second slide 42. Since the second leaf spring 5′ is fastened to this third slide 5′, to the second support-rail part 2′ and to the housing rail 1, it is displaced in the direction “C” and bent. It thus lowers the second support-rail part 2′ and pushes it outward in the direction “C” on the lock side.

FIG. 9 shows an alternative embodiment. Here, instead of a lever, a gearwheel 7′ is provided which engages with corresponding racks 70′, 71′, wherein the racks 70′, 71′ are arranged on the force transmission rod 42 and on the displacement plate 44, respectively. The movement sequence is the same. The fastening to the cover plate 110 is likewise the same.

FIG. 7 illustrates various sections which are identified in FIG. 6. The housing rail has an upper groove 10 (see FIG. 5) in which the force transmission rod 42 and the displacement plate 44 are held so as to be displaceable in a guided manner. Within this groove 10, the lever 7 or the gearwheel 7′ can rotate. The central partition 13 serves for fastening the cover plate 110.

The upper groove 10 is bounded by an upper web 11 which is adjoined by two downwardly projecting side walls 12 of the housing rail 1, thereby forming a downwardly open U-shaped profile. The upper groove 10 is bounded on its underside by a two inwardly projecting lateral webs 14, which leave free a passage 18 for connecting to the slides 41, 43, 43′. A vertical rib 16 projects downward from the lateral webs 14. An inner web 15 is directed inward from each of the vertical ribs 16 at the same height, such that these form a further groove for guided displacement and holding of the slides 41, 43, 43′. The first fastening points 50, 50′ for fastening the leaf springs 5, 5′ are additionally located on these vertical ribs 16.

The cross section of the housing rail 1 is preferably identical along its entire length, such that a bar profile can be used.

The support-rail parts 2, 2′ are also preferably manufactured from bar profiles. They substantially have a box-like cross section with a lower connecting web 26, an upper connecting web 27 and a central connecting web 20. All three webs 20, 26, 27 connect the vertically extending side walls together. Two vertical ribs 28 that extend parallel to one another and protrude upward are present on the upper connecting web 29, preferably in the central region. These serve to form the second fastening points 51, 51′ for the leaf springs 5, 5′.

The central connecting web 20 is preferably held in a groove of the stop plates 21, 21′ and of the guide plates 24, 24′, as is readily discernible in FIG. 3a. This central connecting web 20, 20′ increases the stability of the support profile 2, 2′, in particular in the event of lateral water pressure.

As is readily discernible in FIGS. 5 and 7, the seal profile 3 has a U-shaped cross section with two lateral, upwardly projecting free legs 35 and a lower seal arc 36 that connects these legs 35 together. The seal rests on the ground in a sealing manner by way of this seal arc 36 in the lowered state according to FIG. 7.

Along its legs, the seal profile 3 has fastening beads 32, 33, 34 that are arranged one above the other and are held in corresponding recesses in the support-profile parts 2, 2′. Preferably, they are held in a sliding manner in the recesses, at least in the central region of the seal, i.e. in the region of the transition from one support-profile part to another, such that the seal can move more freely when the support-profile parts 2, 2′ are displaced relative to one another in the longitudinal direction, and is not overextended. Preferably, for this purpose, the recesses have a receiving opening along the entire length or over a subregion, in particular the region between the individual support-profile parts, said receiving opening being overdimensioned compared to the size of the fastening beads, such that the fastening beads are held but are easily displaceable. This can be achieved in the central region for example by mechanical expansion of the recesses or by the fastening beads being undersized.

Preferably, the legs 35 project beyond the uppermost lateral fastening point in order that they bear in a sliding manner against the inner side walls of the housing rail 1.

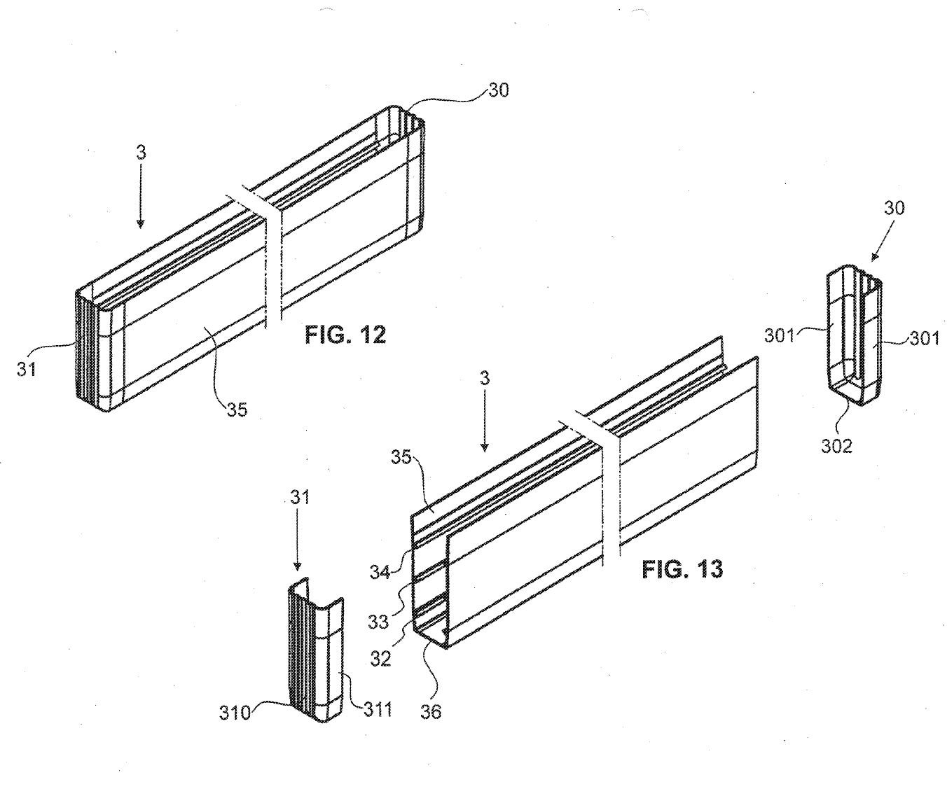

FIGS. 12 and 13 illustrate a seal profile 3 which is suitable for use in the above-described drop-down seals. It has the above-described cross section. The trough-like main body is preferably an extruded profile. Furthermore, the end faces are provided with the terminations 30, 31, such that the seal profile 3 is formed in a closed manner at its ends. Each termination 30, 31 has an end face 310, two side faces 301, 311 that adjoin the latter, and a base face 302. The side faces 301, 311 and base face 302 are tightly connected, for example adhesively bonded or welded, to the corresponding counterparts of the main body. The end sides of the seal profile 3 can be formed in a planar manner, as can the rest of the seal profile. Preferably, however, they have flutes or ribs which increase the sealing action on account of the labyrinthine structure.

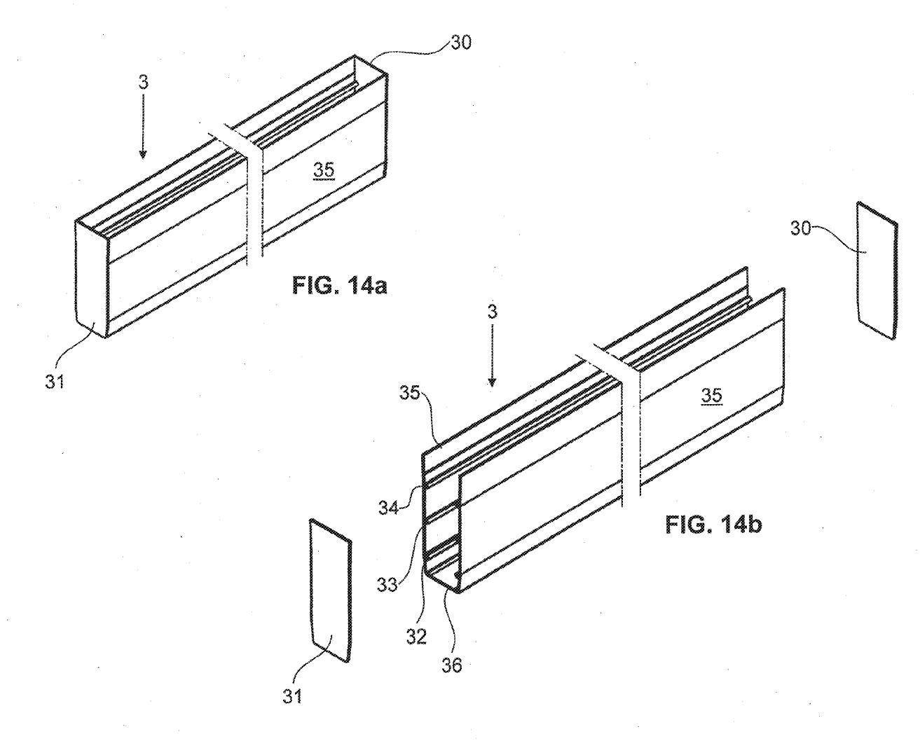

FIGS. 14a and 14b illustrate an alternative embodiment. Here, the terminations 30, 31 are formed in a planar manner, wherein they are again able to be connected, for example adhesively bonded or welded, to the end side of the main body.

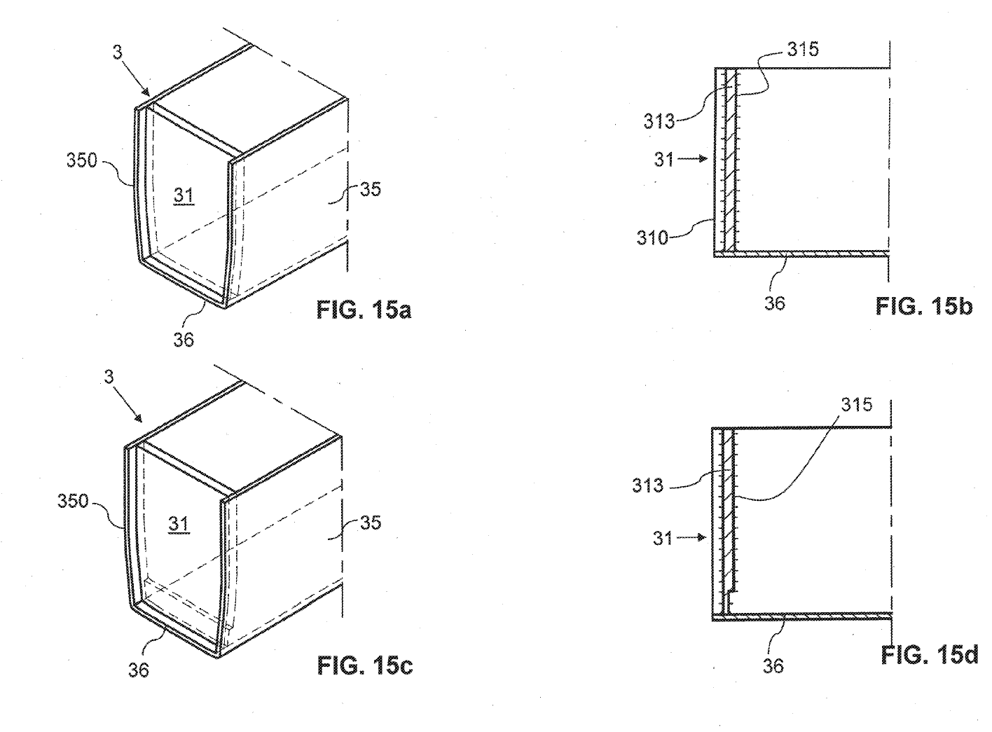

FIGS. 15a and 15b illustrate a further embodiment of the seal profile 3. Only that end of the seal profile 3 which is located at the opposite end of the seal from the actuating button 40 is shown. In this case, this is the lock-side end. The end that is located on the same side as the actuating button, in this case the hinge-side end, is preferably formed in an identical manner. However, it can also be formed otherwise. In particular, it can be formed in an open manner at the end.

The seal profile 3 again has a U-shaped main body with two legs 35 and a seal arc 36 connecting these legs 35 together. In this case, no fastening beads are illustrated, although preferably at least one is present on each side. The end side of the seal profile 3 is again closed by way of the lock-side termination 31. This termination 31 is formed by a planar end plate 313 in this example. It preferably consists of the same material as the rest of the seal profile 3. Preferably, it is made of silicone or rubber. However, it can also consist of a material that has a better sealing action. Preferably, the end plate 313 is watertight.

This end plate 313 is preferably formed in a relatively thick manner, i.e. thicker than the side walls 35 and the seal arc 36 by a multiple, such that it is stiffer and more stable. However, it can also consist of two or more plates that are adhesively bonded or welded together. In the example according to FIGS. 15a and 15b, he end plate 313 is connected, in particular adhesively bonded or welded, to the seal arc 36 and the side walls 35 at a distance from the front edge of said arc 36. The protruding edges of the legs 35 are provided with the reference sign 350. The adhesive seams are provided with the reference sign 315 in the figures.

FIGS. 15c and 15d show a further exemplary embodiment of an end-side termination 31 of the seal profile 3. These terminations, too, can be used on the hinge-side and lock-side. The termination 31 is again formed by a one-part or multipart planar end plate 313. The end plate 313 is formed in a narrowed manner in the direction of the arc 36, in this case by a step. This narrowing or recess has the result that the end-side termination is still formed in a relatively soft and flexible manner in the region of the arc 36, such that, in the lowered state of the seal, it can adapt optimally to the shape of the door casing and of the ground and can provide optimal sealing. This narrowed end plate 313 can be arranged flush with or at a distance from the front edge 350 of the seal profile.

According to the invention, use is preferably made of a seal profile which is formed in an approximately rectangular manner at least at one, and preferably at both end faces, and has an approximately rectangular transition from the ground to the side walls in particular in the lower region. The angle can also be slightly greater than 90°. If planar end plates 313 are used, these are preferably rectangular or trapezoidal with angles only slightly different than 90°.

The terminations 31 according to FIGS. 15a to 15d can be produced easily and cost-effectively, wherein they still ensure an optimal end-side seal.

In order that the seal can withstand a high water level or heavy driving rain as far as possible, the end-side terminations 30, 31 preferably extend approximately over the entire height of the support-rail parts 2, 2′. However, in order that the pressure plates 23, 23′ can be set, the termination 30, 31 in the upper peripheral region 303 is preferably not connected firmly to the main body, but rather releasably. However, in particular when use is made of terminations 30, 31 having the shape according to FIGS. 12 and 13, sealing is nevertheless ensured. This also applies when terminations according to FIGS. 14a to 15d are used.

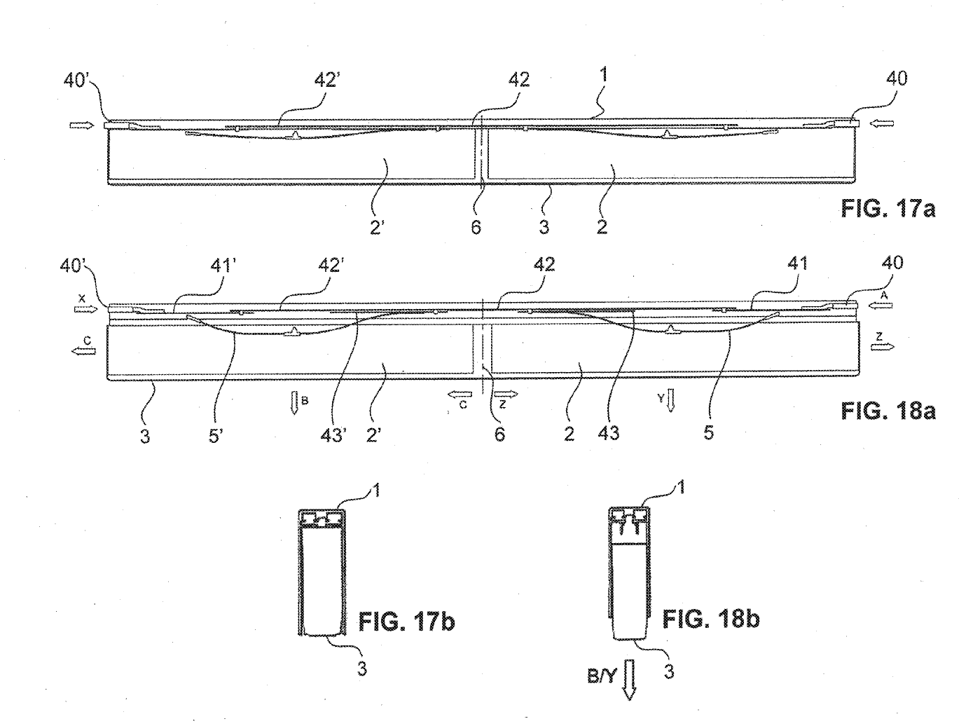

FIGS. 17 to 19 illustrate a second embodiment. Identical parts are provided with the same reference signs and are not described again. In contrast to the first exemplary embodiment, rather than being triggered and activated on one side, the seal is triggered and activated on both sides here. A second actuating button 40′ is provided, which protrudes from the opposite side of the housing rail 1 from the first actuating button 40.

The first actuating button 40 is connected to the first slide 41, the first force transmission rod 42 and the third slide 43′.

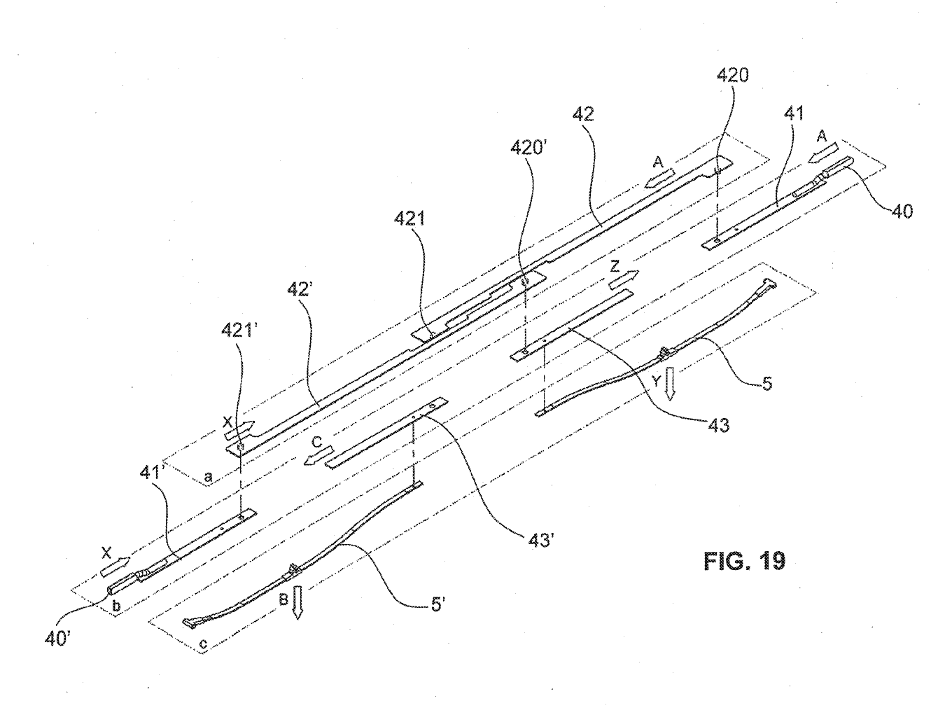

The second actuating button 40′ is connected to a left-hand first slide 41′ which is connected to a second force transmission rod 42′, the latter being connected to the second slide 43. Preferably, the second force transmission rod 42′ is formed in a mirror-symmetrical manner to the first force transmission rod 42. This is readily discernible in FIG. 19.

Both rods 42, 42′ have recesses into which the other force transmission rod 42, 42′ projects. In this embodiment, no other reversal or force transmission element, for example a lever 7 or a gearwheel 7′, is provided. However, in order to coordinate the movement, such a force transmission element can additionally be used, analogously to the first example, wherein, in this case, it connects the two force transmission rods 42, 42′ together.

The first actuating button 40 thus acts on the third slide 43′ and the second leaf spring 5′ via the force transmission rod 42. The second actuating button 40′ acts on the second slide 43 and the first leaf spring 5 via the second force transmission rod 42′. The transmission of the triggering force to the springs and to the sealing strip thus takes place in a crosswise manner. This type of two-sided triggering, using leaf springs, is an independent invention and is claimed here independently of the remaining elements, in particular independently of the lateral seal, the support rail that is displaceable in the longitudinal direction, and the trough-like seal profile.

In a further embodiment that is not illustrated here, the drop-down seal is likewise triggered on both sides, wherein, in contrast to the embodiment according to FIG. 19, a direction reversal analogous to the embodiment according to FIG. 6 takes place on both sides. In other words, as in FIG. 6, a first actuating button 40 and a first slide 41 displace a force transmission rod 42 in the direction “X”, which displaces a displacement plate 44 in the opposite direction “Y” via a pivoting element 7, 7′ or some other direction reversal element, wherein the displacement plate 44 displaces a second slide 43 in the same direction “D” and thus lowers the support-rail part 2 via a first leaf spring 5 and displaces it in the opposite direction to the external triggering force. Provided on the opposite side of the housing rail 1 is a second actuating button 40′ and a second set of the abovementioned elements, specifically the slide, the force transmission rod, the direction reversal element, the displacement plate and the leaf spring, which likewise lower a second support-rail part 2′ and displace it in the opposite direction to the external triggering force acting on the second actuating button 40′. There is no operative connection between the first and the second set of elements. This mechanism can be used with the trough-like seal profile described here or with some other seal profile, in particular a multipart seal profile. In this case, depending on the embodiment, the seal can have end-side and/or downwardly acting sealing elements.

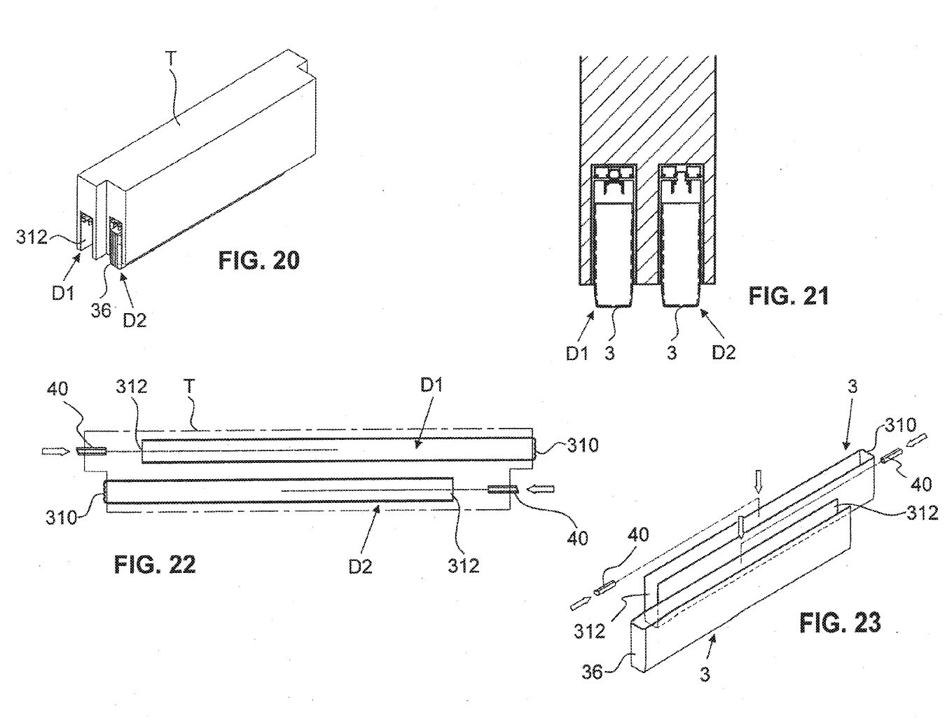

FIGS. 20 to 23 illustrate a third exemplary embodiment of a seal system according to the invention. In a door leaf T, two seals D₁, D₂ are arranged one behind the other in the transverse direction. The two seals are preferably formed in an identical manner. They are preferably the abovementioned drop-down seals. However, they can also be other types of seals, in particular brush seals.

These two seals each have a seal profile 3 which is formed in a trough-like manner. However, in this case, only one end face 310 is formed in a closed manner. The opposite second end face 312 is formed in an open manner. The two seals D₁ and D₂ are arranged with respect to one another such that their closed end faces 310 are located opposite one another in the longitudinal direction. In this way, the door leaf T is sealed off on both sides.

If the seals are drop-down seals, the triggering button 40 is preferably located on the opposite side from the closed end side 310, as is readily discernible in FIGS. 22 and 23.

In a further embodiment, the seal is a brush seal, as is illustrated in FIGS. 25 to 27. This seal again has a housing rail 1 with a sealing strip arranged therein. The housing rail 1 is fastened to a bottom end side or in a lower groove of a door leaf by means of a fastening clip 9.

The sealing strip comprises an elastomeric or rubber-elastic seal profile 3′ which is held in the housing rail 1. It is preferably adhesively bonded to the pressure plates 22, 22′, 22″ described below.

As is readily discernible in FIG. 26, the seal profile 3′ has a strip-shaped flat main body which is bent upward at its two opposite ends. It forms a stop surface 38. At least one outwardly directed rib 37 is integrally formed on this main body. Said rib extends along the entire length and as far as the ends of the upwardly bent regions of the main body. Preferably, several ribs are provided. In this example, there are two ribs 37.

In addition, stop plates 21, 21′, 21″ are rigidly connected to the housing rail. The lateral stop plates 21, 21′ are preferably fastened to the upper web 11 of the housing rail 1, and the lower stop plate 21″ is preferably fastened to the two side walls 12 of the housing rail 1. As in the previous examples, one or more guide pins 23, 23′, 23″ are held in a displaceable manner in these stop plates 21, 21′, 21″, said guide pins 23, 23′, 23″ being firmly connected to pressure plates 22, 22′, 22″. The downwardly directed horizontal pressure plate 22″ preferably extends approximately along the entire length and width of the seal profile 3′ and presses against the stop surface 38. The lateral pressure plates 22, 22′ preferably extend over the entire height and width of the end face of the seal profile and likewise press against the stop surface 38. This stop surface 38 is preferably formed in a planar manner.

Rather than a single downwardly directed horizontal pressure plate 22″, it is also possible for two or more such pressure plates 22″ to be arranged one after the other in the longitudinal direction of the seal and to be fastened individually to the housing rail. This has the advantage that the seal profile 3′ can be displaced downward at two or more points independently of one another. This is illustrated by the vertical arrows in FIG. 26. Thus, the brush seal can adapt easily to uneven ground.

By means of setting screws, the relative position between the stop plate 21, 21′, 21″ and pressure plate 22, 22′, 22″ can be set with the aid of a hand tool 8. Thus, even in the case of the brush seal illustrated here, the lateral and downwardly acting contact pressure of the brush seal can be set on site.

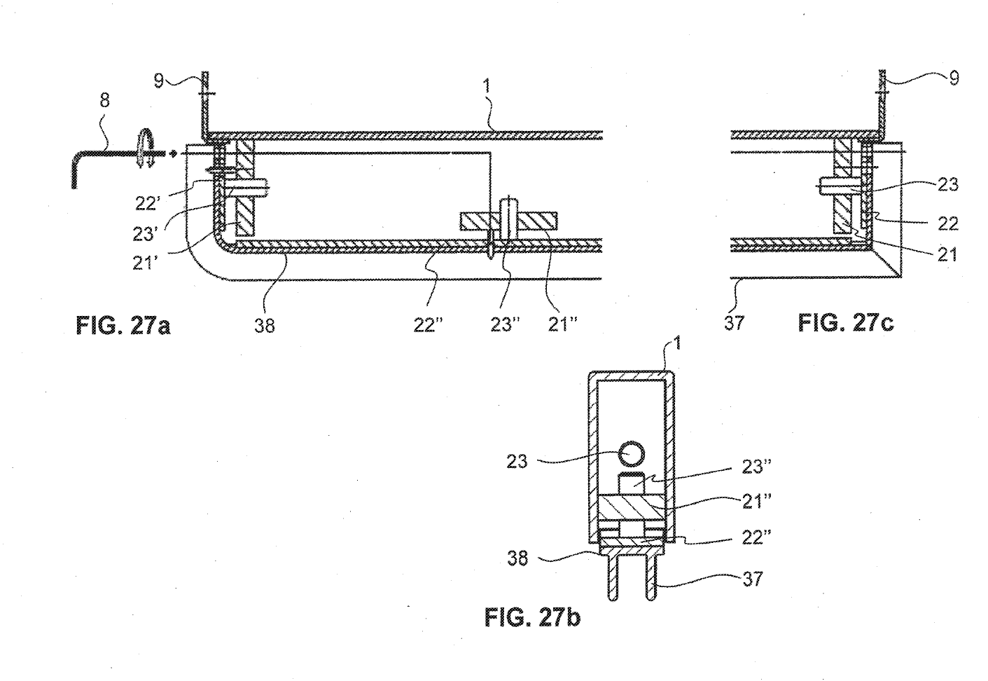

FIG. 27c illustrates a further embodiment of the seal profile 3′. Instead of rounded corners, the corner is formed with a right angle here. This has the advantage that it provides optimal sealing into the corner of the door casing.

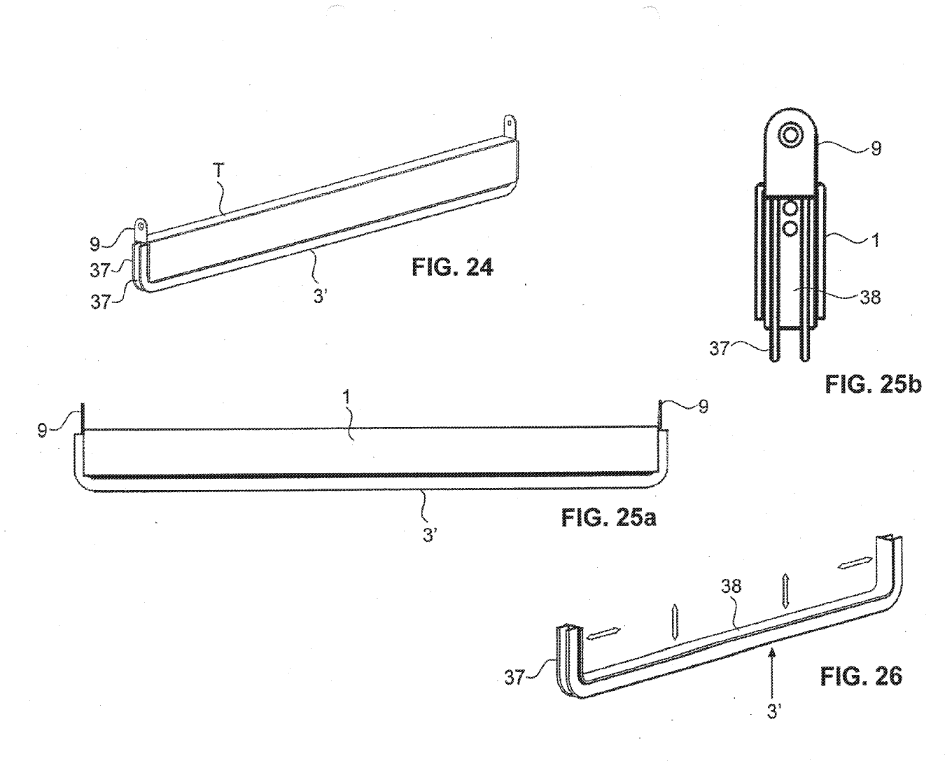

In the other embodiments of the brush seal according to FIGS. 24 to 27, only lateral stop plates or only a lower stop plate and associated pressure plate are provided.

This seal profile 3′ can also be used with an actuating mechanism as is described with reference to FIGS. 1 to 19 and FIGS. 28a and 28b, respectively. In these cases, the seal profile 3′ is arranged on the support-rail parts 2, 2′ and is pushed laterally and preferably also downwardly thereby.

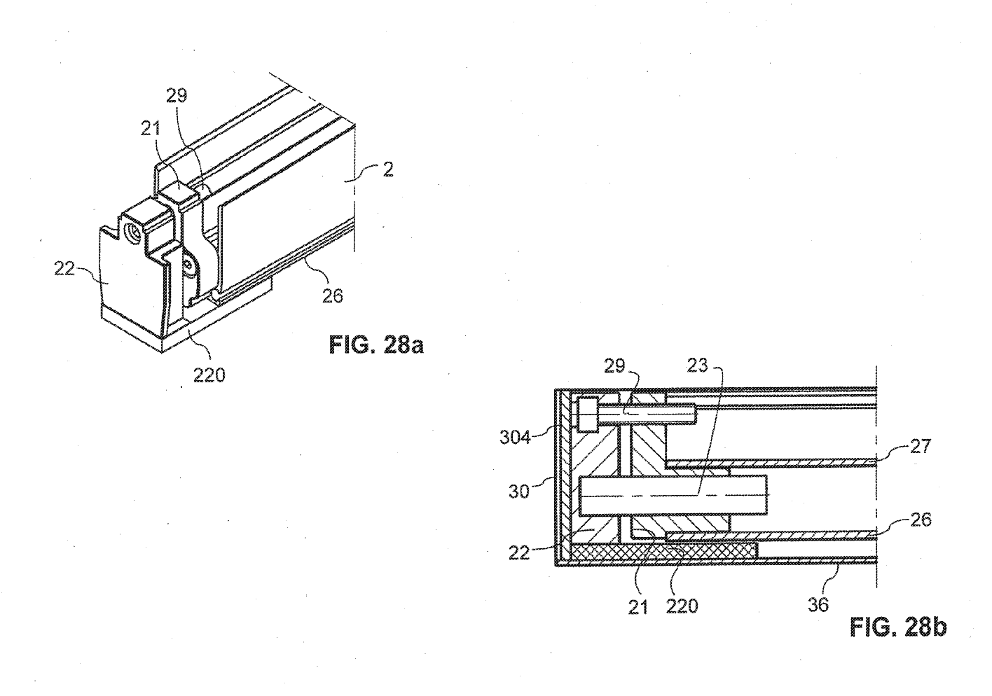

FIGS. 28a and 28b show a variant which can be used for example in the above-described exemplary embodiments. This variant can be used at the hinge-side and/or lock-side end of the seal. The support rail again has a first support-rail part 2 and a stop plate connected thereto, and a pressure plate 22. Guide pins 23 and a setting screw 29 allow the settable connection between the parts. The upper connecting web of the first support-rail part 2 is again provided with the reference sign 27 and the lower connecting web with the reference sign 26.

Fastened to the underside of the pressure plate 22 is a sealing cushion 220. This extends preferably in the transverse direction of the seal across the entire width of the pressure plate 22. In the longitudinal direction of the seal, the sealing cushion 220 is longer than the pressure plate 22 and extends preferably over the stop plate 21 as far as the lower connecting web 26. Preferably, however, it does not extend along the entire length of the seal, but is provided only in one or two end-side end regions of the seal.

The sealing cushion 220 is preferably fastened only to the pressure plate 22 and can move freely relative to the stop plate 21 and to the lower connecting web 26. The sealing cushion 220 is preferably in the form of a shallow cuboid. It is preferably formed in a soft manner and consists for example of foam rubber, silicone or rubber. However, it can also be formed in a stiff and hard manner and consist for example of a thermosetting material.

As is readily discernible in FIG. 28b, the sealing cushion 220 is located between the support rail 2 and seal arc 36 in the assembled state of the seal. If the support rail 2 is lowered with the seal profile 3, the sealing cushion 220 pushes downward and forward at the ends, fills the corner region of the seal profile 3 and thus optimizes sealing in the lower corner region of the seal. In the exemplary embodiment illustrated here, a reinforcement plate 304 is additionally illustrated at the end side behind the end-side termination 30. However, this reinforcement plate 304 is optional.

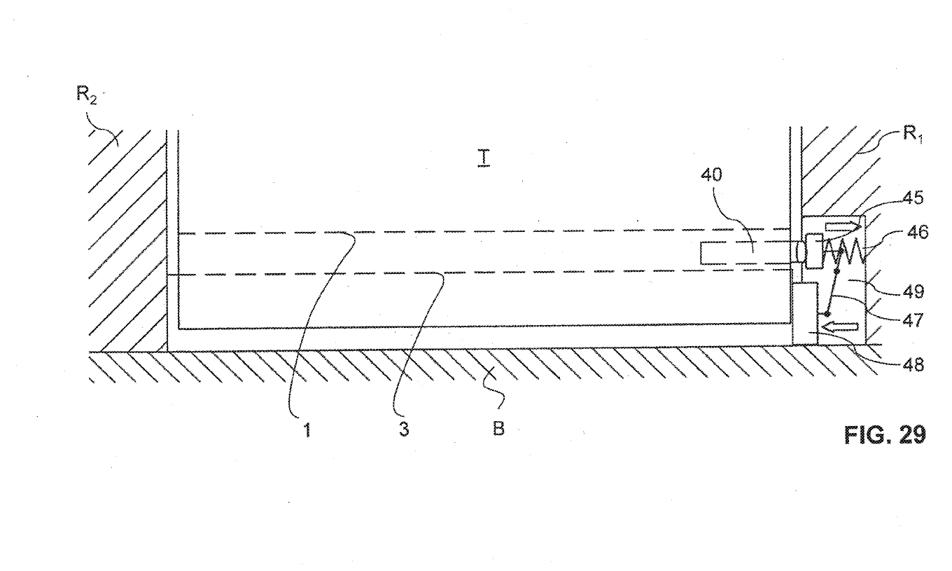

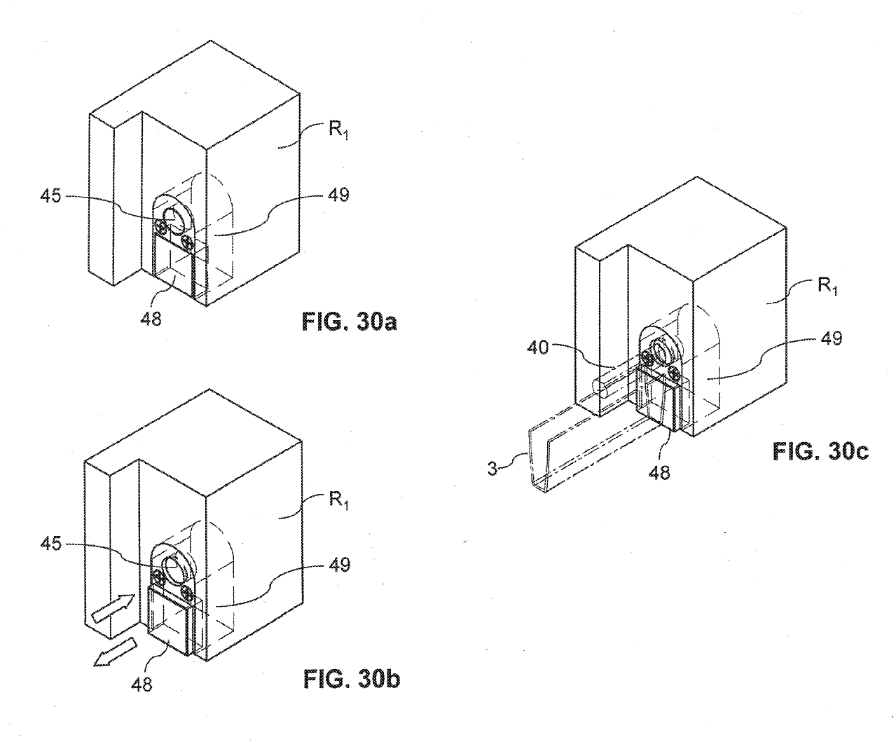

FIGS. 29 and 30a to 30c illustrate a further embodiment which likewise allows end-side sealing on both sides. This embodiment can be combined with the abovementioned embodiments. However, it can also be combined with lowering mechanisms which have one- or two-sided triggering mechanisms known from the prior art. In particular, it can be combined with lowering mechanisms as have already been specified in this text as prior art.

FIG. 29 schematically illustrates a seal that is arranged in a door leaf T. The two sides of the door casing are denoted R₁ and R₂. The ground on which the lowered seal rests is denoted B.

Of the seal, the housing rail 1 and the already lowered seal profile 3 resting on the ground are. The actuating button 40 has been depressed and, via the lowering mechanism (not illustrated), has displaced the support rail 2 and the seal profile 3 toward the left in the direction of the lock-side door-casing side R₂. Thus, the seal profile 3 bears against the door casing on this side. Preferably, the seal profile 3 is formed in a closed manner on this end side, as described above.

As is readily discernible in FIGS. 30a to 30c, a recess 49 is present in the door casing on the side of the actuating button 40, in this case on the hinge side. Arranged in this recess is an additional module which comprises a stop 45, a restoring spring 46, a lever mechanism 47, and a sealing body 48. Preferably, the additional module has a housing or a frame in order to accommodate these elements.

In FIG. 30a, the situation is illustrated with the door open. The sealing body 48 is preferably aligned with the surrounding surface of the door casing. It additionally closes off the opening it passes through in a sealing manner. In FIG. 30b, the possible directions of movement of the sealing body 48 are illustrated with arrows, wherein it is actuable by means of the lever mechanism 47. FIG. 30c shows that, in the lowered state of the seal, the end of the seal profile 3 bears against the sealing body 48 and as a result this end region and corner region is sealed.

As illustrated in FIG. 29, the actuating button 40 does not press against the door casing itself when the door leaf T is closed, but against the stop 45 of the additional module. This stop 45 is pressed deeper into the door casing, counter to the spring force of the restoring spring 46, until the opposing force suffices to push the actuating button 40 in and to lower the support rail 2 with the seal profile 3 in a known manner.

However, the displacement of the stop 45 has the result that the lever mechanism 47 connected thereto is actuated, said lever mechanism moving the sealing body 48 out of the door casing in the opposite direction, i.e. in the direction parallel to the displacement of the actuating button 45, wherein it is still held in the door casing and seals the recess 49 with its periphery. The sealing body 48 rests on the ground B and provides sealing downward. It also contacts the end-side end of the seal profile 3 and provides joint end-side sealing therewith.

The lever mechanism is preferably configured and set such that it ensures a contact pressure downward and/or on the end side.

The seal profile 3 can be formed in an open manner on this end side. Preferably, however, it is formed in a closed manner, and even more preferably as described above.

The sealing body 48 is preferably manufactured from the same material as the seal profile 3, in particular silicone or rubber. Preferably, it is formed in a soft and/or flexible manner in order to ensure optimal sealing. However, it can also be stiff and in particular consist of a thermosetting material. It is preferably watertight.

In an alternative embodiment, the additional module can be activated by an additional triggering element which interacts with or is operatively connected to the triggering element of the sealing strip, i.e. with the abovementioned actuating button.

The seal according to the invention allows end-side sealing. It additionally allows sealing with a single sealing strip which comprises the two end sides and the lower region of the seal and can thus provide sealing even for the lower corner region of the door casing. It thus allows optimal protection against driving rain and floodwater, wherein it is nevertheless constructed in a relatively simple and slender manner.

### LIST OF REFERENCE SIGNS

1 Housing rail
10 Upper groove
11 Upper web
110 Cover plate
111 Access opening
12 Side wall
13 Partition
14 Lateral web
15 Inner web
16 Vertical rib
17 Lower groove
18 Passage
2First support-rail part
20 Central connecting web
21 Hinge-side stop plate
22 Hinge-side pressure plate
220 Sealing cushion
23 Guide pin
23′ Guide pin
24 First guide plate
25 Guide pin
26 Lower connecting web
27 Upper connecting web
28 Vertical rib
29 Setting screw
290 Locknut
2′ Second support-rail part
20′ Central connecting web
21′ Lock-side stop plate
22′ Lock-side pressure plate
23′ Guide pin
24′ Second guide plate
26′ Lower connecting web
27′ Upper connecting web
2″ Support rail
21″ Lower stop plate
22″ Lower pressure plate
23″ Guide pin
3 Seal profile
3′ Seal profile
30 Hinge-side termination
301 Side face
302 Base face
303 Upper peripheral region
304 Reinforcement plate
31 Lock-side termination
310 End face
311 Side face
312 Open end side
313 End plate
315 Adhesive seam
32 Lower fastening bead
33 Central fastening bead
34 Upper fastening bead
35 Free leg
350 Protruding edge
36 Seal arc
37 Rip
38 Stop face
4 Lowering mechanism
40 Actuating button
40′ Actuating button
41 First slide
41′ First slide
410 Fastening hole
42 Force transmission rod
420 Fastening bolt
421 Fastening bolt
42′ Second force transmission rod
420′ Fastening bolt
421′ Fastening bolt
43 Second slide
430 Fastening hole
430′ Fastening hole
431 Fastening point
43′ Third slide
431′ Fastening point
44Displacement plate
440 Fastening bolt
45 Stop
46 Restoring spring
47 Lever mechanism
48 Sealing body
49 Recess
5 First leaf spring
50 First fastening point
51 Second fastening point
52 Third fastening point
5′ Second leaf spring
50′ First fastening point
51′ Second fastening point
52′ Third fastening point
6 Intermediate space
7 Lever
70 First guide cam
71 Second guide cam
7′ Gearwheel
70′ First rack
71′ Second rack
8 Hand tool
9 Fastening clip
L Longitudinal axis
S Pivot axis
T Door leaf
D₁ First seal
D₂ Second seal
R₁ Hinge-side door-casing side
R₂ Lock-side door-casing side
B Ground

1. A seal device for a door leaf or window casement, wherein the seal device has a housing rail, an actuating mechanism and a sealing strip which is held in the housing rail and is movable relative to the housing rail 1 by means of the actuating mechanism, wherein, in the actuated state of the seal device, the sealing strip provides end-side sealing in both directions of a longitudinal axis of the seal device.

2. The seal device as claimed in claim 1, wherein at least a part of the sealing strip is movable outward in both directions of the longitudinal axis in order to provide end-side sealing.

3. The seal device as claimed in claim 1, wherein the sealing strip has a support rail.

4. The seal device as claimed in claim 3, wherein the support rail is movable outward in the direction of the longitudinal axis of the seal device in order for the sealing strip to provide end-side sealing.

5. The seal device as claimed in claim 3, wherein the support rail is provided with an adjustable pressure plate on at least one of its end sides.

6. The seal device as claimed in claim 4, wherein, in the outwardly moved and lowered state of the sealing strip, the support rail protrudes beyond the housing rail on both end sides, and wherein the support rail does not protrude beyond the end sides in the raised state of the housing rail.

7. The seal device as claimed in claim 4, wherein the support rail has at least a first and a second support-rail part which are arranged one behind the other in a spaced-apart manner along the longitudinal axis and the spacing of which from one another is variable.

8. The seal device as claimed in claim 7, wherein the actuating mechanism has a force transmission rod that is displaceable in the longitudinal direction, a pivoting element and a displacement element, wherein the force transmission rod is displaceable parallel to the longitudinal axis and brings about a movement of the sealing strip, wherein the pivoting element is pivotable about a pivot axis perpendicular to the longitudinal axis during longitudinal displacement of the force transmission rod and wherein the displacement element is displaceable parallel to the longitudinal axis and in the opposite direction to the displacement of the force transmission rod by the pivoting element pivoting, wherein the first support-rail part is connected to the displacement element and the second support-rail part is connected to the force transmission rod such that the displacement element displaces the first support-rail part outward and such that the force transmission rod displaces the second support-rail part outward in the opposite direction to the first support-rail part.

9. The seal device as claimed in claim 8, wherein the pivoting element is a lever, wherein the force transmission rod and the displacement element each have a guide cam, said guide cams being engaged with the lever and moving the lever upon movement of the force transmission rod or the displacement element, respectively.

10. The seal device as claimed in claim 8, wherein the pivoting element is a gearwheel, wherein the force transmission rod and the displacement element each have a rack, said racks being engaged with the gearwheel and moving the gearwheel upon movement of the force transmission rod or the displacement element, respectively.

11. The seal device as claimed in claim 7, wherein the actuating mechanism has a first force transmission rod that is displaceable in the longitudinal direction and a second force transmission rod that is displaceable counter to the longitudinal direction, wherein the two force transmission rods are displaceable parallel to the longitudinal axis and bring about a movement of the sealing strip, wherein the first support-rail part is connected to the second force transmission rod and the second support-rail part is connected to the first force transmission rod such that the second force transmission rod displaces the first support-rail part outward in a direction parallel to its own displacement direction and such that the first force transmission rod displaces the second support-rail part outward in the opposite direction to the first support-rail part and in a direction parallel to its own displacement direction

12. The seal device as claimed in claim 7, wherein the actuating mechanism has a first force transmission rod that is displaceable in the longitudinal direction and a second force transmission rod that is displaceable counter to the longitudinal direction, wherein the two force transmission rods are displaceable parallel to the longitudinal axis and bring about a movement of the sealing strip, wherein the first support-rail part is connected to the first force transmission rod and the second support-rail part is connected to the second force transmission rod via respective reversal elements such that the first force transmission rod displaces the first support-rail part outward in the opposite direction to its own displacement direction and such that the second force transmission rod displaces the second support-rail part outward in the opposite direction to the first support-rail part and in the opposite direction to its own displacement direction.

13. The seal device as claimed in claim 7, wherein the at least first and second support-rail parts each have a guide element at their mutually adjacent end sides, said guide elements being connected together and allowing a relative movement of adjacent support-rail parts exclusively parallel to the longitudinal axis.

14. The seal device as claimed in claim 3, wherein the sealing strip is lowerable and raisable transversely to the longitudinal axis of the seal device and wherein the sealing strip has the support rail for fastening the sealing strip to the housing rail and a seal profile held on the support rail, in order to seal a gap between the door leaf or window casement and the ground in the lowered state of the sealing strip.

15. The seal device as claimed in claim 14, wherein the seal profile simultaneously provides sealing downwardly and on both end sides in the lowered state.

16. The seal device as claimed in claim 14, wherein the sealing strip is lowerable and raisable by means of the actuating mechanism.

17. The seal device as claimed in claim 14, wherein the seal profile is formed in a manner closed in a watertight manner at least on one end side, and at least over half of its height.

18. The seal device as claimed in claim 7 wherein the sealing strip is lowerable and raisable transversely to the longitudinal axis of the seal device and wherein the sealing strip has the support rail for fastening the sealing strip to the housing rail and a seal profile held on the support rail, in order to seal a gap between the door leaf or window casement and the ground in the lowered state of the sealing strip and wherein the seal profile is formed in one piece lengthwise and is held jointly by the at least two support-rail parts.

19. The seal device as claimed in claim 7 wherein the sealing strip is lowerable and raisable transversely to the longitudinal axis of the seal device and wherein the sealing strip has the support rail for fastening the sealing strip to the housing rail and a seal profile held on the support rail, in order to seal a gap between the door leaf or window casement and the ground in the lowered state of the sealing strip and wherein the displacement element or the second force transmission rod lowers the first support-rail part and displaces the first support-rail part outward, and wherein the force transmission rod or the first force transmission rod lowers the second support-rail part and displaces it-second support-rail part outward in the opposite direction to the first support-rail part.

20. The seal device as claimed in claim 1, wherein a triggering element is provided which actuates the actuating mechanism, and wherein an additional module is provided which is arranged outside the housing rail and which is actuable by means of the triggering element, wherein the additional module has a sealing body which is movable in the direction of the sealing strip when the additional module is actuated, with the result that, in the actuated state of the seal device, the sealing body contacts the sealing strip on an end side of the sealing strip and, together with the latter, seals the door leaf or window casement with respect to a door casing or a wall.

21. The seal device as claimed in claim 20, wherein the additional module has a spring-loaded lever mechanism for displacing the sealing body.

22. The seal device as claimed in claim 20, wherein the sealing body is formed in an elastic and watertight manner.

23. The seal device as claimed in claim 5, wherein the support rail is provided with an adjustable pressure plate on both end sides.

24. The seal device as claimed in claim 17, wherein the seal profile is formed in a manner closed in a watertight manner on both end sides.

25. The seal device as claimed in claim 17, wherein the seal profile is formed in a manner closed in a watertight manner over approximately its entire height.
